(19) United States
(12) Patent Application Publication
(10) Pub. No.: US 2009/0162049 A1
(43) Pub. Date: Jun. 25, 2009

(54) IMAGING DEVICE

(76) Inventor: Kenichi MARUYAMA, Aichi (JP)

Correspondence Address: OSTROLENK FABER GERB & SOFFEN, 1180 AVENUE OF THE AMERICAS, NEW YORK, NY, 100368403, US

(21) Appl. No.: 12/255,214

(22) Filed: Oct. 21, 2008

(30) Foreign Application Priority Data
Dec. 25, 2007 (JP) 2007-331779

(51) Int. Cl. G03B 17/00

(52) U.S. Cl. 396/428

(57) ABSTRACT

This attempts to lighten the burden on users when lifting a camera head from a table side. The camera holding arm 140 that holds the camera head 120 is axially supported on the arm shaft support shaft 204 which has the one way clutch 240 interposed for axial support to rotate at the ridge part 118. When doing forward rotation operation Xkap so as to pull up the camera holding arm 140 from the minimum inclination position of the side of the table 110, that rotation direction matches the rotation allowed direction of the one way clutch 240. Thus, the camera holding arm 140 is in a free state around the shaft of the arm shaft support shaft 204.

### CROSS-REFERENCE TO RELATED APPLICATIONS

The present application claims the priority based on Japanese Patent Application No. 2007-331779 filed on Dec. 25, 2007, the disclosure of which is hereby incorporated by reference in its entirety.

### BACKGROUND

1. Technical Field

The present invention relates to an imaging device that images an imaging-object mounted on a table.

2. Related Art

With this type of imaging device, so as to be able to do imaging from above the imaging-object as well as from the side or from a diagonal direction when imaging an imaging-object mounted on a table using a camera head, the camera head is held in relation to the table by an arm. This kind of camera head holding state can be seen in Japanese Patent Laid-open Gazette No. 2006-180452, for example.

With this type of imaging device, as described previously, it is necessary to handle imaging from the imaging-object side direction and diagonal direction as well, so with the patent reference noted above, the imaging device is such that the frictional force during arm rotating is adjusted, and it is possible to stop the arm at any desired position using that frictional force. Then, when lifting the camera head from the side of the table upward, the user needs to turn the camera holding arm using force which is resistant not only to the camera head weight but also to the aforementioned frictional force, so proposed is the assistance of this arm rotating operation with auxiliary force using a spring.

However, though with an increase in the auxiliary force using the spring to increase the assistance, the arm rotating operation becomes easier, there was a limit to the assistance because it was not possible to improvidently increase the auxiliary force using the spring for the convenience of being able to stop the arm at any desired position by adjusting the frictional force during arm rotating. Thus, when the camera head is brought up from the table side, a burden is put on the user to output a force greater than the force equivalent to the weight of the camera head.

### SUMMARY

An object of the present invention is to reduce the burden on the user when bringing up the camera head from the table side, in order to address the problems noted above.

In order to solve at least a part of these problems stated above, the present invention uses the following constitution.

An imaging device for imaging an area of a table on which an imaging-object is to be mounted, comprising:

a camera holding arm that holds the camera head so as to image the imaging-object from the top side of the table using a camera built in the camera head, and

arm shaft support module for giving shaft support such that the camera holding arm can rotate in relation to the table so that it is possible for the camera head to achieve an imaging stance for imaging the imaging-object from the table top side and a table side head stance close to the top surface of the table,

this arm shaft support module having:

an arm shaft support shaft that rotatably supports the camera holding arm to the table,

an adjustment unit for adjusting the frictional force that occurs when the camera holding arm rotates around the arm shaft support shaft, and for exerting adjusted frictional force on the camera holding arm to hold the camera holding arm in an inclined position after rotating,

a release unit for releasing the camera holding arm from the frictional force only when the camera holding arm is rotating with the imaging side stance change from the table side head stance toward the imaging stance, and

a stance changing resistance unit which has resistance to the imaging side stance change of the camera holding arm only when the camera head is in the table side head stance.

With the imaging device of the constitution noted above, the camera head with a camera built in is held by the camera holding arm, and this camera holding arm is rotatably supported so as to be able to turn freely in relation to the table by the arm shaft support shaft of the arm shaft support module. Thus, by rotating the camera holding arm, the camera head is able to achieve the imaging stance for imaging the imaging-object from the top side of the table and the table side head stance close to the top surface of the table.

The camera holding arm rotates extending between both of these stances, but because the frictional force adjusted by the adjusting unit is received, after rotating, it stops at the inclined position. This state is described together with the imaging side stance change of the camera holding arm from the table side head stance toward the imaging stance.

When the camera head is in the table side head stance, the stance change resistance unit has resistance to the imaging side stance change of the camera holding arm, so the camera holding arm stops at this table side head stand position. When rotating the camera holding arm toward the imaging stance so as to overcome this resistance, the arm rotating operation for causing this stance change is an operation that rotates the camera holding arm by the imaging side stance change from the table side head stance toward the imaging stance, so the camera holding arm is released by the release unit from the frictional force exerted by the adjustment unit. Thus, when the user rotates the camera holding arm so as to cause this imaging side stance change, the user does not have to exert force on the camera holding arm for overcoming this frictional force, and the burden on the user is approximately only the weight of the camera head. Then, when the user puts his hand on the camera holding arm, and rotates it to bring it up to the imaging side stance of the camera head, or to any inclined position of the imaging side stance change process, for example, the inclined position for imaging the imaging-object from the side or a diagonal direction, the rotating operation up to that position is done with a force corresponding to the weight of the camera head as described previously. Thus, it is possible to not place an excessive burden on the user. In fact, when the user removes his hand from the camera holding arm and stops the rotating operation of the imaging side stance change, at that point in time, the release by the release unit of the frictional force on the camera holding arm is cancelled, and the camera holding arm receives the frictional force adjusted by the adjustment unit and stops at the inclined position after rotating. Because of this, the camera head stops at the position above the imaging-object or at a position at the side or diagonal direction, so it is possible to do imaging of the imaging-object without interference.

On the other hand, if the user returns the camera holding arm to the table side head stance position, the camera holding arm stops at this table side head stance position by the imaging side stance change resistance due to the stance change resistance unit. Because of this, it is possible to not have inadvertent rotating of the camera holding arm from this table side head stance position.

It is possible to use various modes for the imaging device described above. For example, it is possible to have the release unit interposed between the arm shaft support shaft and the camera holding arm and be mounted on the arm shaft support shaft, and to have it be a one way clutch that allows only rotating of the camera holding arm with the imaging side stance change. By doing this, it is possible to lighten the operating burden of the user with a simple method of mounting a one way clutch.

It is also possible to have a stance change regulating unit be a mechanism that gives a sense of restraint that works together with a ball, a concave site in which the ball enters, and a spring that biases the ball toward the concave site. By doing this, in addition to the camera holding arm stopping at the table side head stance, when the user returns the camera holding arm to the table side head stance, it is possible to give the user a sense of restraint for the completion of the change to this stance, increasing convenience.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a perspective view of the imaging device 100 of the embodiment.

FIG. 2 is a right side plan view of this imaging device 100.

FIG. 3 is a perspective view showing the imaging device 100 in a state with both arms of the camera holding arm 140 and the lighting unit holding arm 150 turned to the table side.

FIG. 4 is an explanatory drawing showing the state with the cover part of the table 110 removed in order to explain the arm shaft support module 200 for the ridge part 118.

FIG. 5 is a cross section diagram showing the arm shaft support module 200 including the shaft of the arm shaft support with FIG. 4 cut away vertically.

FIG. 6 is an exploded perspective view showing this arm shaft support module 200 in an exploded state from the diagonal front of the device.

FIG. 7 is an exploded perspective view of the key parts from direction A in FIG. 6.

### DESCRIPTION OF THE PREFERRED EMBODIMENTS

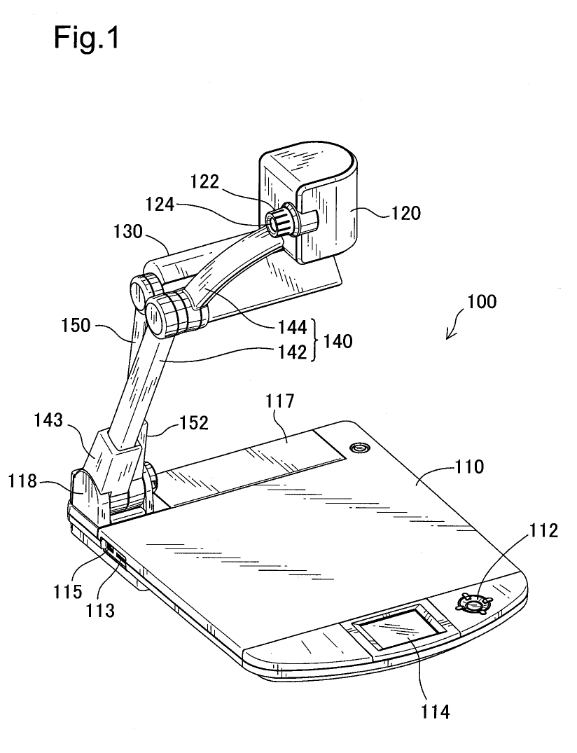

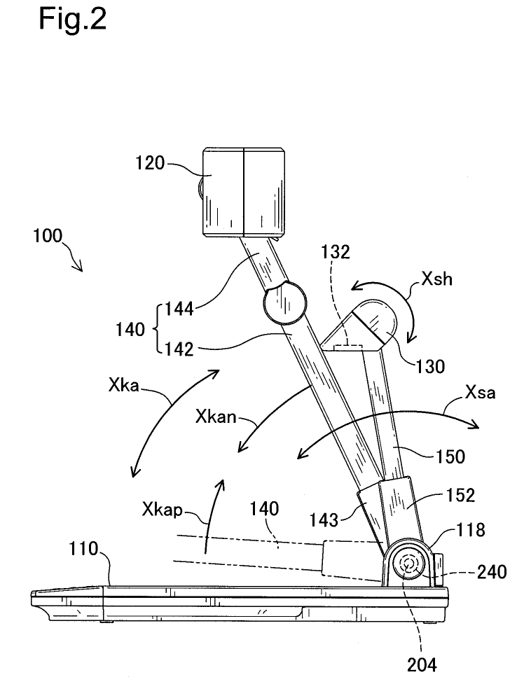

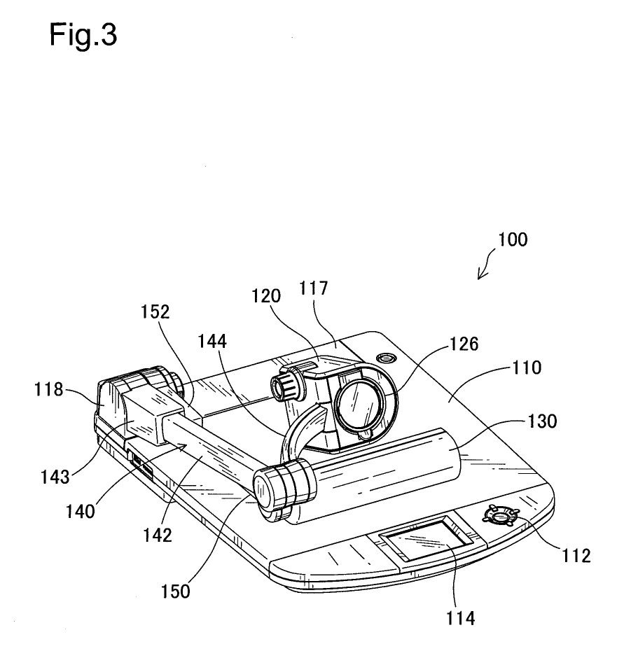

The following describes modes for embodying the present invention in terms of examples based on drawings. FIG. 1 is a perspective view of the imaging device 100 of the embodiment. FIG. 2 is a right side plan view of this imaging device 100. FIG. 3 is a perspective view showing the imaging device 100 in a state with both arms of the camera holding arm 140 and the lighting unit holding arm 150 turned to the table side.

As shown in the drawing, the imaging device 100 includes a table 110 on which the imaging-object is mounted, a camera head 120 for imaging the imaging-object (not illustrated) on this table 110, and a lighting unit 130 for lighting the imaging-object on the table 110. The table 110 forms a rectangular flat plate shape for which the front side has a rounded extension, includes a switch group 112 and a monitor 114 at the top surface of the front side, and further includes a memory card mounting mechanism 113 and a USB (Universal Serial Bus) terminal 115 at the left back side wall. This switch group 112 switches the lights on and off, and of the monitor display source, displays switching of the menu screen displayed on the monitor 114, and additionally has a switching function for the function settings of this device and the like, but it has no direct relation to the key points of the present invention, so the description of these structure is not discussed here.

Also, the table 110 includes a cover 117 that can open and close freely on the top surface of the table at the table back end side, and using this cover, the connector terminal group (not illustrated) for connection with external devices are covered and hidden. The cover 117 is opened and closed in flap form, and with the illustrated closed state, it becomes substantially a single surface with the table top surface of the table 110, and the surface of the cover part is a surface that is continuous with the table top surface.

The camera head 120 is held by the camera holding arm 140 in relation to the table 110. This camera holding arm 140 includes a table side arm 142 and a camera side arm 144, and is held to rotate on the table 110 at the base 143 of the table side arm 142. The camera side arm 144 is linked and fixed with the camera head 120, and is respectively free to rotate at the linking part with the table side arm 142. Thus, the camera head 120 is integrated with the camera side arm 144 and is able to rotate at the tip of the table side arm 142.

Also, the camera head 120 has a built in camera (not illustrated), and includes a zoom operating switch 122 and an auto focus switch 124, which are regularly used when imaging the imaging-object, at the side surface. The zoom operating switch 122 is installed so as to encompass the auto focus switch 124, and decides the user's desired zoom level according to the forward/reverse turning operation by the user. The auto focus switch 124 is constituted as a pressing switch, whereby normally the auto focus is off, and the auto focus operation is executed by a pressing operation by the device user.

The lighting unit 130 is held by a lighting unit holding arm 150 in relation to the table 110. This lighting unit holding arm 150 is held so as to rotate on the table 110 at the base 152, and the lighting unit 130 is held so as to rotate at the tip side.

The camera holding arm 140 and the lighting unit holding arm 150 are axially supported on the same shaft to be able to rotate at the left inner corner ridge part 118 of the table 110, and so that the level of inclination in relation to the table 110 changes, turn on the same shaft in relation to the table 110. The imaging device 100 has an arm that is axially supported to be able to rotate in this way, so it is possible to use various modes with arm rotating. Here, before describing the constitution of the rotating shaft support of both arms, we will give a brief description of various modes that can be used for the imaging device 100.

From the aforementioned both arm shaft support state and the lighting unit 130 shaft support state, as shown in FIG. 2, the camera holding arm 140 rotates so that the inclination level in relation to the table 100 changes as shown by the arrow Xka in the drawing, and from the state shown by the solid line in this FIG. 2, the camera head 120 is able to turn up to the state approaching the top surface of the table 110. The camera head 120 has the stance (imaging stance) shown in FIG. 1 and FIG. 2 during imaging the imaging-object mounted on the table 110, and the imaging-object mounted on the table 110 is imaged from the top side of the table. FIG. 3 shows the state of the camera side arm 144 rotating in relation to the table side arm 142, and when the camera head 120 approaches the top surface of the table 110 in this way, the camera holding arm 140 is made to maintain the stance after rotating by the restraint mechanism described later. On the other hand, when the camera head 120 has the imaging stance of FIG. 2, the rotating of the camera holding arm 140 is restricted by the stopper of the shaft support structure described later, and the camera holding arm 140 has the largest inclination (maximum inclination) in relation to the table 110.

The lighting unit holding arm 150 rotates so that the inclination level changes in relation to the table 110 as shown by the arrow Xsa in FIG. 2, and from the state shown in this FIG. 2, it is possible to rotate up to the state of the lighting unit 130 approaching the top surface of the table 110. Also, the lighting unit holding arm 150 can rotate until the lighting unit 130 is at a position behind the position shown in FIG. 2. The lighting unit 130 rotates as shown by the arrow Xsh in the drawing at the linking part with the lighting unit holding arm 150. In this case, during imaging of the imaging-object mounted on the table 110, the lighting unit holding arm 150 is positioned at the back side from the camera holding arm 140, and the lighting unit 130 normally has the stance (lighting stance) shown in the drawing behind the camera head 120, and lights the imaging-object mounted on the table 110 at a diagonal from the top side of the table.

In addition to this kind of imaging of the imaging-object on the top surface of a table, the imaging device 100 can have the storage mode shown in FIG. 3. With this mode, the lighting unit holding arm 150 rotates so that the inclination level in relation to the table 110 is minimal, and the lighting unit 130 has the table side lighting unit stance near the top surface of the table 110 and with the case outside wall overlapping the table 110. For the camera holding arm 140, the table side arm 142 is rotated so that the inclination level in relation to the table 110 is minimal, and the camera side arm 144 is rotated almost 180° at the linking part with the table side arm 142, and when seen from the horizontal direction, this overlaps with the table side arm 142. By this kind of arm rotating, the camera head 120 has the close up lens 126 that it has at the front surface faced slanting upward, and has the table side head stance near the top surface of the table 110.

In other words, with the rotating operation noted above of the camera holding arm 140 and the lighting unit holding arm 150, the camera head 120 is held with the stance changed from the imaging stance of FIG. 1 and FIG. 2 described previously to the table side head stance shown in FIG. 3. The same is also rotate for the lighting unit 130, and this lighting unit 130 is held with the stance changed from the lighting stance of FIG. 1 and FIG. 2 described previously to the table side lighting unit stance shown in FIG. 3.

In addition, the imaging device 100 does imaging the imaging-object behind or in front of the device using the camera head 120 by rotating the camera side arm 144 to the device back side or front side with the table side arm 142 of the camera holding arm 140 left as is with the maximum inclination noted above. Note that during this kind of device front or back imaging, with the camera head 120, it is possible to have the close up lens 126 un-mounted. When doing device front or back imaging with the camera head 120 in this way, the rotate position of the camera side arm 144 in relation to the table side arm 142 is made to be determined by the restraint mechanism (not illustrated) that is incorporated in the rotate linking part of the camera side arm 144 and the table side arm 142.

The lighting unit 130 can have a stance overlapping the table 110 shown in FIG. 3 when doing imaging in front or back of the device using the aforementioned camera head 120, but that stance can be adjusted to any position in front or back of the device that does not interfere with imaging. Note that the lighting unit 130 has the lighting location of its illumination light inclined, and it includes a window 132 for transmitting the illumination light to that inclination location.

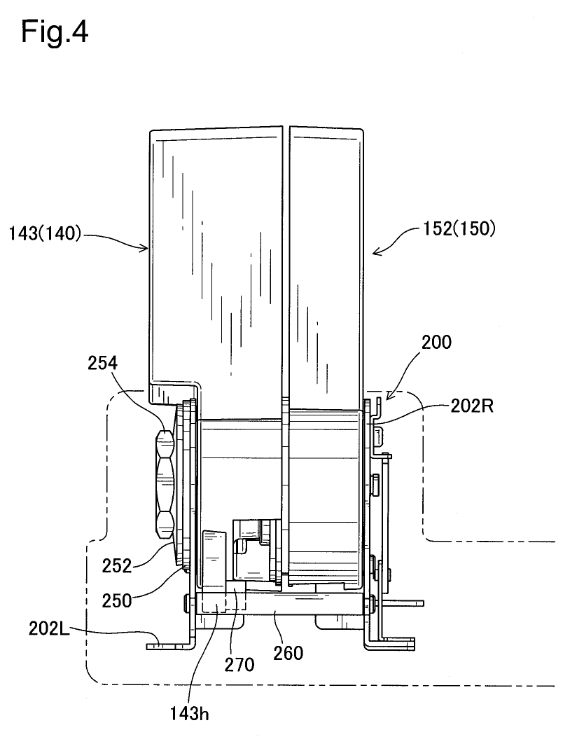

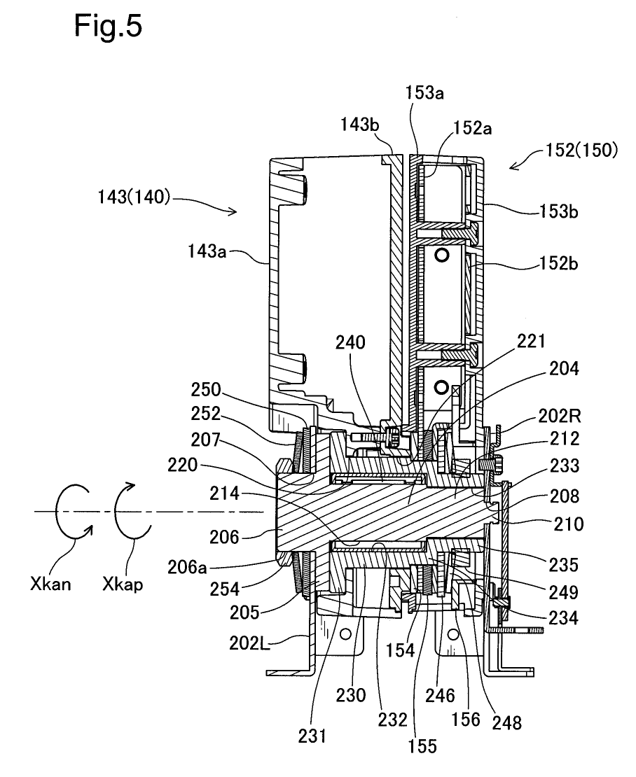

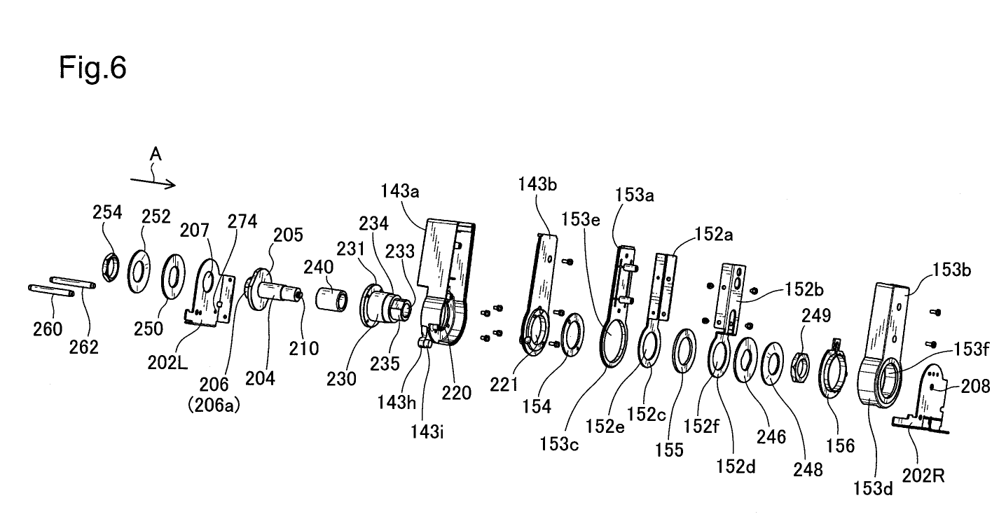

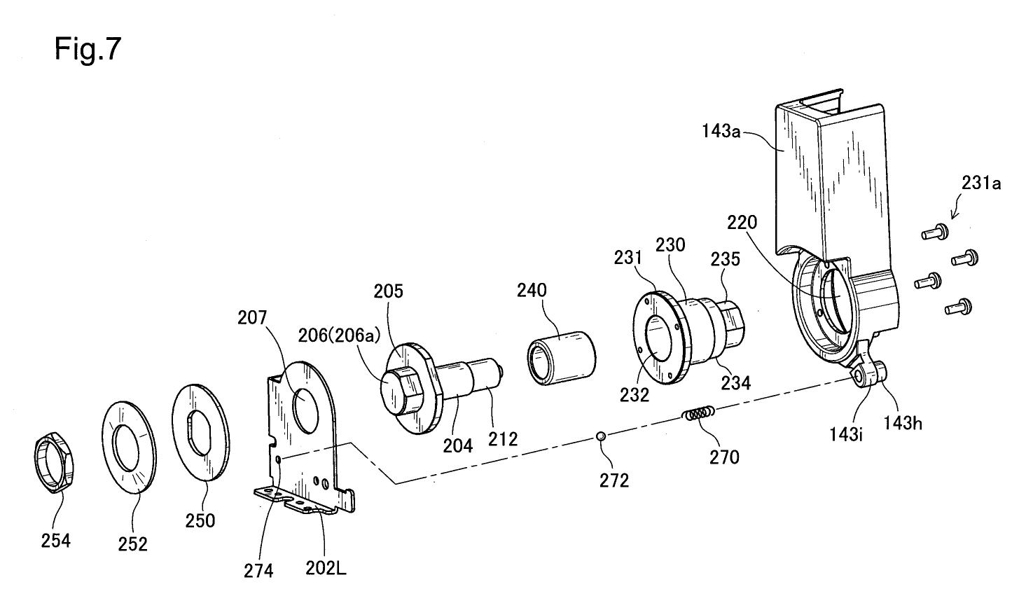

Here, the shaft support constitution of both arms of the camera holding aim 140 and the lighting unit holding arm 150 is described below. FIG. 4 is an explanatory drawing showing the state with the cover part removed for describing the arm shaft support module 200 with the ridge part 118. FIG. 5 is a cross section diagram showing the arm shaft support module 200 with FIG. 4 cut vertically including the shaft of the arm shaft support. FIG. 6 is an exploded perspective view showing the exploded state of this arm shaft support module 200 seen from the diagonal front of the device. FIG. 7 is an exploded perspective view of the key parts from the A direction in FIG. 6.

As shown in these drawings, the arm shaft support module 200 includes left and right plates 202L and 202R facing each other fixed to the skeletal frame (not illustrated) of the table 110, and the arm shaft support shaft 204 extended between both of these plates. Then, using this arm shaft support shaft 204, the camera holding arm 140 (specifically the base 143) and the lighting unit holding arm 150 (specifically the base 152) are axially supported so as to rotate between the aforementioned left and right frames.

The arm shaft support shaft 204 is set as a multi-level shaft, and on the side of the plate 202L, includes a first engaging shaft 206 that engages with a first shaft support hole 207 of that plate, and on the side of the plate 202R, includes a second engaging shaft 210 that engages with a second shaft support hole 208 of that plate. Also, the arm shaft support shaft 204 includes a flange 205 at the base of the first engaging shaft 206, and in addition to the tip of the first engaging shaft 206 being a male screw shaft 206a, it has a sleeve engaging shaft unit 212 and a clutch mounting shaft unit 214 extending from the side of the second engaging shaft 210 to the flange 205.

The base 143 of the camera holding arm 140 axially supported on the aforementioned arm shaft support shaft 204 is constituted with an aluminum die cast first part 143a and second part 143b joined after positioning. The first part 143a includes a sleeve engaging hole 220 at the bottom edge side, and a clutch sleeve 230 is engaged in that engaging hole. With the second part 143b as well, equipped is a sleeve engaging hole 221 for which a clutch sleeve 230 engages in the bottom edge side. Specifically, the base 143 includes the flange 231 of the clutch sleeve 230 fixed to the first part 143a by a screw 231a as shown in FIG. 7 after the clutch sleeve 230 is engaged in both of the aforementioned engaging holes of the first part 143a and the second part 143b which have been positioned and joined.

The clutch sleeve 230 includes a one way clutch 240 that allows only one directional rotation and is stored the clutch storage unit 232 of the flange 231 side, and the inner side of this storage unit is the insertion hole 233 in which is inserted the sleeve engaging shaft unit 212 of the arm shaft support shaft 204. In addition, the clutch sleeve 230 includes an arm shaft support shaft unit 234 for axially supporting the base 152 of the lighting unit holding arm 150 described later, and its tip is the male screw shaft 235. The rotational allowance by the one way clutch 240 will be described later.

The base 152 of the lighting unit holding arm 150 has a first part 152a and a second part 152b which are made by press molding steel plates joined after positioning, and these parts are constituted covered by left and right covers 153a and 153b. Both the first and second parts and left and right covers are equipped with through holes 152e, 152f, 153d, and 153f respectively at the disk parts 152c, 152d, 153c, and 153d at the bottom edge side thereof, and these are fixed by screws as described later with spacers 154 to 156 sandwiched between the disk parts. In this case, the spacer 156 is made of resin. In a state with the spacers 154 to 156 sandwiched, the base 152 of the lighting unit holding arm 150 is attached and mounted on the arm shaft support shaft part 234 of the clutch sleeve 230 in which is inserted the sleeve engaging shaft unit 212 of the arm shaft support shaft 204.

Specifically, the base 152 of the lighting unit holding arm 150 in a state with the both the aforementioned parts and the left and right covers fixed is attached so as to have the arm shaft support shaft part 234 of the clutch sleeve 230 which is integrated with the base 143 of the camera holding arm 140 engage in the aforementioned through hole. By doing this, the lighting unit holding arm 150, specifically, the first part 152a and the second part 152b and the left and right covers 153a and 153b, are axially supported by the arm shaft support shaft part 234 of the clutch sleeve 230 and rotate around that shaft. This arm shaft support shaft part 234 is concentric with the arm shaft support shaft 204 which is the rotating shaft of the camera holding arm 140, so the camera holding arm 140 and the lighting unit holding arm 150 are axially supported to be able to rotate on the same shaft in relation to the table 110 so that the level of inclination in relation to the table 110 changes.

For attaching of the base 143 of the camera holding arm 140 and the base 152 of the lighting unit holding arm 150, first, the base 143 and the base 152 of both arms are attached. Specifically, as described previously, after fixing the clutch sleeve 230 to the base 143 of the camera holding arm 140, the arm shaft support shaft part 234 of this already fixed clutch sleeve 230 is engaged in the aforementioned through hole that the base 152 of the lighting unit holding arm 150 has. Then, a plain washer 246 and a disc spring 248 are interposed on the male screw shaft 235 of the clutch sleeve 230, and a nut 249 is screwed together and tightened. By doing this, the camera holding arm 140 and the lighting unit holding arm 150 have their respective bases overlapping as shown in FIG. 4 and FIG. 5, and these become integrated via the clutch sleeve 230.

In fact, the force that occurs by deflection of the disc spring 248 operates as the pressing force of the lighting unit holding arm 150, and by doing deflection margin adjustment of the disc spring 248 using the nut 249, the frictional force when the lighting unit holding arm 150 rotates independently around the shaft of the arm shaft support shaft part 234 with the clutch sleeve 230, specifically, the frictional force during independent rotating of the lighting unit holding arm 150, is adjusted. The frictional force of the lighting unit holding arm 150 that has gone through deflection margin adjustment of the disc spring 248 is adjusted so that it is possible for the lighting unit holding arm 150 to stop at the position after rotating when the lighting unit holding arm 150 is rotated independently around the shaft of the arm shaft support shaft part 234 and has stopped rotating at any position.

After integrating both arms in this way, the one way clutch 240 is stored in the clutch storage unit 232 of the clutch sleeve 230, and in that state, the arm shaft support shaft 204 is engaged in the one way clutch 240. By doing this, the sleeve engaging shaft unit 212 of the arm shaft support shaft 204 is entered in the insertion hole 233 of the clutch sleeve 230. In a state with the arm shaft support shaft 204 attached in this way, the first engaging shaft 206 of the arm shaft support shaft 204 is engaged in the first shaft support hole 207 of the plate 202L, and the second shaft support hole 208 of the plate 202R is engaged on the second engaging shaft 210. Note that this second engaging shaft 210 is prevented from falling out by an E ring (not illustrated).

Then, the plain washer 250 and the disc spring 252 are interposed on the first engaging shaft 206, and the nut 254 is screwed together and tightened on the male screw shaft 206a. The arm shaft support shaft 204 has the flange 205 of the first engaging shaft 206 of one end side of the shaft in contact with the plate 202L, and the shaft base end surface of the second engaging shaft 210 of the other end side of the shaft in contact with the plate 202R, and in this state, undergoes tightening by the nut 254. Then, the force that occurs with the deflection of the disc spring 252 operates as the pressing force of the flange 205 on the plate 202L, and the frictional force of the first engaging shaft 206 on the first shaft support hole 207 when the already engaged arm shaft support shaft 204 is rotated around the shaft support hole 207 is adjusted by the deflection margin adjustment of the disc spring 252 by the nut 254. This frictional force when the arm shaft support shaft 204 rotates becomes the frictional force during rotating of the camera holding arm 140, but the engagement of the camera holding arm 140 and the arm shaft support shaft 204 is performed by the one way clutch 240 stored in the clutch sleeve 230 as described previously, so the result is as follows.

First, the relationship of the clutch sleeve 230 and the arm shaft support shaft 204 described below. In the state after the aforementioned arm attachment, between the flange 231 of the clutch sleeve 230 and the flange 205 of the arm shaft support shaft 204, and between the insertion hole 233 of the clutch sleeve 230 and the sleeve engaging shaft unit 212 of the arm shaft support shaft 204, with clearance secured, the arm shaft support shaft 204 is mounted on the clutch sleeve 230, and the clutch sleeve 230, and by extension the camera holding arm 140, are engaged via this one way clutch 240. The one way clutch 240 allows only one directional rotation, so we will describe the camera holding arm 140 and the arm shaft support shaft 204 engaged via the one way clutch 240 correlated to the rotating operation of the camera holding arm 140.

As described using FIG. 1 to FIG. 3, the camera holding arm 140 engaged as noted above on the arm shaft support shaft 204 is rotated forward and in reverse as shown by arrow Xka in FIG. 2 from the maximum inclination position which is the imaging stance of the camera head 120 up to the minimum inclination position which is the table side head stance for which the camera head 120 is close to the table 110. In this FIG. 2, the rotating operation of the camera holding arm 140 from the minimum inclination position to the maximum inclination position side is set as the forward rotation operation Xkap, and the rotating operation of the camera holding arm 140 from the maximum inclination position to the minimum inclination position side is set as the reverse rotation operation Kkan. When the rotation direction of the camera holding arm 140 is set in this way, the one way clutch 240 allows the concerned rotation operation without any resistance occurring for the forward rotation operation Xkap of the camera holding arm 140. On the other hand, the one way clutch 240 functions as a stopper for the reverse rotation operation Xkan of the camera holding arm 140.

This forward and reverse operation is described in light of FIG. 5 which shows the state when the camera holding arm 140 is at the maximum inclination position. The camera holding arm 140 shown in FIG. 5 is already in the maximum inclination position, so by the operation of the user, the reverse rotation operation Xkan is started so as to have this tip to the front side of the drawing toward the dotted line in FIG. 2 or the minimum inclination position shown in FIG. 3. In this case, the one way clutch 240 functions as a stopper as described above and does not allow rotation, so the arm shaft support shaft 204 is integrated with the clutch sleeve 230 and by extension the camera holding arm 140 by the one way clutch 240 which functions as a stopper. Because of this, when the camera holding arm 140 is made to do the reverse rotation operation Xkan, the frictional force when rotating the arm shaft support shaft 204 around the shaft support hole 207 becomes the frictional force when the camera holding arm 140 is rotating. Then, the frictional force at this time, specifically the frictional force when the camera holding arm 140 is made to undergo the reverse rotation operation Xkan, is adjusted by the deflection margin adjustment of the disc spring 252 by the nut 254, and when that operation stops at any position with the reverse rotation operation Xkan of the camera holding arm 140 around the arm shaft support shaft unit 234 shaft, adjustment is done so that it is possible for the camera holding arm 140 to stop at a position after the operation stops. Note that the lighting unit holding arm 150 stops at the rotating position for which the rotating frictional force was adjusted with the concerned arm independently as described previously, so the lighting unit holding arm 150 causes the reverse rotation operation Xkan together with the camera holding arm 140.

On the other hand, as shown by the dotted line in FIG. 2 or in FIG. 3, when the camera holding arm 140 which is in the minimum inclination position undergoes by user operation the forward rotation operation Xkap so as to occur at the maximum inclination position side shown in FIG. 1 or FIG. 5, the one way clutch 240 allows this forward rotation operation Xkap as noted above. Because of this, the engagement of the arm shaft support shaft 204 and the clutch sleeve 230, and by extension, the camera holding arm 140 is undone. Thus, when the camera holding arm 140 undergoes forward rotation operation Xkap, the clutch sleeve 230 is in a free state in relation to the arm shaft support shaft 204, and combined with the fact that there is clearance between the flange 231 of the clutch sleeve 230 and the flange 205 of the arm shaft support shaft 204, and between the insertion hole 233 of the clutch sleeve 230 and the sleeve engaging shaft unit 212 of the arm shaft support shaft 204, the camera holding arm 140 causes the forward rotation operation Xkap without receiving the frictional force when the arm shaft support shaft 204 rotates around the shaft support hole 207. Then, when the operation of the forward rotation operation Xkap of the camera holding arm 140 stops midway, the camera holding arm 140 receives the weight of the camera head 120 and tries to rotate to the reverse rotation operation Xkan side, but in this state, the one way clutch 240 functions as a stopper, so the camera holding arm 140 receives the frictional force noted above at the forward rotation operation Xkap operation stop position, and stops at this position. Note that even during this kind of forward rotation operation Xkap, the lighting unit holding arm 150 causes the forward rotation operation Xkap together with the camera holding arm 140.

The arm shaft support module 200 for which both arms are rotatably supported additionally has the following constitution in order to regulate the camera holding arm 140 rotating end stance, specifically, the arm end position when the camera head 120 is in the aforementioned imaging stance and the table side head stance. As shown in FIG. 4 and FIG. 6, the arm shaft support module 200 includes shafts 260 and 262 installed between the left and right plates 202L and 202R. Both of these shafts regulate the interval between both plates and also function as a plate reinforcing member.

The camera holding arm 140 includes a projection 143h that projects from the outer periphery to the end part of the first part 143a, and this projection 143h is positioned between the shafts 260 and 262 which are installed between both plates. Thus, when this projection 143h is in contact with the shaft 260 at the front side in FIG. 6, the camera holding arm 140 has the maximum inclination angle in relation to the table 110 such that the camera head 120 is in the imaging stance noted above, and stops at that position. Meanwhile, when the projection 143h is in contact with the shaft 262 of the inner side in FIG. 6, the camera holding arm 140 has the minimum inclination angle in relation to the table 110 such that the camera head 120 is in the aforementioned table side head stance, and stops at that position.

Also, the arm shaft support module 200 has the arm end position regulated by the shafts 260 and 262 when the camera head 120 is in the aforementioned table side head stance, and in addition to these shafts, has the following constitution so as to stop at the arm end position when the camera holding arm 140 is in the table side head stance. As shown in FIG. 6 and FIG. 7, the arm shaft support module 200 includes a spring storage potion 143i having a bottom at the tip side of the projection 143h, and after compressing and storing the spring 270 in this spring storage potion 143i, biasing force is exerted on the ball 272 by this spring 270. The ball 272 receives the biasing force of the spring 270 and always presses on the side of the plate 202L, and enters the ball seating hole 274 of the plate 202L only when the camera holding arm 140 is in the arm end position with the aforementioned table side head stance. In other words, the spring 270 stored in the spring storage unit 143i and the ball seating hole 274 of the plate 202L give the user a sense of restraint when the user does the rotating operation of the camera holding arm 140 to the arm end position in the case of the table side head stance, and also, there is resistance when the camera holding arm 140 positioned at this arm end position causes the reverse rotation operation Xkan, and the camera holding arm 140 is stopped at this arm end position.

There are the following advantages with the imaging device 100 of this embodiment having the constitution described above. To do imaging an imaging-object, when the user puts his hand on the camera holding arm 140, specifically the table side arm 142, and does the forward rotation operation Xkap so as to pull up this arm from the minimum inclination position shown by the dotted line in FIG. 2, that rotation direction matches the rotation allowed direction of the one way clutch 240. Thus, the camera holding arm 140 is in a free state around the shaft of the arm shaft support shaft 204, so when the user tries to make the camera holding arm 140 do the forward rotation operation Xkap, it is not necessary to exert on the camera holding arm 140 a force so as to overcome the frictional force adjusted by the deflection margin of the disc spring 252, and the burden placed on the user is only approximately the weight of the camera head 120. Thus, it is possible to not place an excessive burden on the user, increasing convenience and operability.

Also, when the user removes his hand from the arm after stopping this operation midway with the camera holding arm 140 undergoing the forward rotation operation Xkap, the camera holding arm 140 receives the weight of the camera head 120 and attempts to operate to the side of the reverse rotation operation Xkan. However, with the operation change to this reverse rotation operation Xkan, because the one way clutch 240 functions as a stopper in relation to this operation, at the point in time that the operation is changed, the free state around the shaft of the arm shaft support shaft 204 is cancelled, and the frictional force adjusted by deflection margin of the disk sprint 252 works on the camera holding arm 140, so the camera holding arm 140 stops at the position at the point of time of the operation change. Because of this, it is possible for the user to do imaging the imaging-object without interference simply by doing the forward rotation operation Xkap on the camera holding arm 140 until the arm inclination corresponds to the imaging position for the desired imaging from the front or back side of the imaging-object, with the camera holding arm 140 stopped at that arm inclination position. Then, even when operating in this way with the camera holding arm 140 up to any arm inclination position, as described above, an excessive burden is not placed on the user.

In addition, when the camera head 120 is in the table side head stance and the camera holding arm 140 is in the minimum inclination position shown by the dotted line in FIG. 2, the ball 272 enters the ball seating hole 274 of the plate 202L. Thus, this ball entry becomes resistance when the camera holding arm 140 in the minimum inclination position tries to start the forward rotation operation Xkap. Because of this, it is possible to have the preferable state of not having the camera holding arm 140 inadvertently start the forward rotation operation Xkap from the minimum inclination position. Also, the entry of the ball 272 to the ball seating hole 274 gives the user a sense of restraint when an attempt is made to return the camera holding arm 140 to the minimum inclination position shown by the dotted lines in FIG. 2, so it is possible to make the user aware of the operation end, which is preferable. In this case, stopping of the camera holding arm 140 at the minimum inclination position shown by the dotted lines in FIG. 2 is set with good reproducibility with the contact (see FIG. 6) of the projection 143h that the camera holding arm 140 and the shaft 262 have, so combined with giving a sense of restraint by entry of the ball 272 in the ball seating hole 274, the operability and convenience are increased.

With the imaging device 100 of this embodiment, it is possible to turn the lighting unit holding arm 150 around the clutch sleeve 230 which is coaxial with the arm shaft support shaft 204 which is the rotating shaft of the camera holding arm 140. In addition, by the frictional force adjustment that has gone through the deflection margin adjustment of the disc spring 248, it is possible to rotate the lighting unit holding arm 150 together with the camera holding arm 140. Because of this, as shown in FIG. 3, when the camera holding arm 140 and the lighting unit holding arm 150 are both at the table side, if the hand is placed only on the camera holding arm 140 to lift up that arm, it is possible to also rotate the lighting unit holding arm 150, so the convenience is increased. Also, with the aforementioned frictional force adjustment, it is possible to rotate the lighting unit holding arm 150 independently as well, so when doing imaging of the imaging-object, it is possible to freely change the lighting location, which is desirable.

Note that when trying to return the camera holding arm 140 to the minimum inclination position shown by the dotted line in FIG. 2, pressing the camera holding arm 140 with the force for overcoming the frictional force noted above is sufficient, and it is possible to ensure the same operability as conventionally. In this case as well, it is possible to rotate the lighting unit holding arm 150 so that it is also in the stance shown in FIG. 3 simply by pressing the camera holding arm 140.

The present invention is not limited to the embodiments and modes noted above, and various modes can be implemented in a scope that does not stray from the key points. For example, when doing forward rotation operation Xkap of the camera holding arm 140, release of the frictional force that went through deflection adjustment was performed using the one way clutch 240, but it is also possible to constitute this using a collet chuck in which a tapered shaft and the concerned shaft enter. With this constitution, when doing the forward rotation operation Xkap on the camera holding arm 140, so as to separate the collet chuck from the tapered shaft, using a cam mechanism or the like, the collet chuck and the taper shaft are driven opposite to the shaft direction, and when the camera holding arm 140 reverse rotation operation Xkan is stopped and the camera holding arm 140 is made to do the reverse rotation operation Xkan, the collet chuck and the tapered shaft can be driven opposite to the shaft direction using a cam mechanism or the like so that the tapered shaft enters the collet chuck.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An imaging device for imaging an area of a table on which an imaging-object is to be mounted, comprising:
a camera holding arm that holds the camera head so as to image the imaging-object from the top side of the table using a camera built in the camera head, and
arm shaft support module for giving shaft support such that the camera holding arm can rotate in relation to the table so that it is possible for the camera head to achieve an imaging stance for imaging the imaging-object from the table top side and a table side head stance close to the top surface of the table,
this arm shaft support module having:
an arm shaft support shaft that rotatably supports the camera holding arm to the table,
an adjustment unit for adjusting the frictional force that occurs when the camera holding arm rotates around the arm shaft support shaft, and for exerting adjusted frictional force on the camera holding arm to hold the camera holding arm in an inclined position after rotating,
a release unit for releasing the camera holding arm from the frictional force only when the camera holding arm is rotating with an imaging side stance change from the table side head stance toward the imaging stance, and
a stance changing resistance unit which has resistance to the imaging side stance change of the camera holding arm only when the camera head is in the table side head stance.

2. An imaging device in accordance with claim 1, wherein the release unit is interposed between the arm shaft support shaft and the camera holding arm and is mounted on the arm shaft support shaft, and is a one way clutch that allows only rotating of the camera holding arm with the imaging side stance change.

3. An imaging device in accordance with claim 1 or claim 2, wherein the stance change regulating unit is a mechanism that gives a sense of restraint used together with a ball, a concave part in which the ball enters, and a spring that biases the ball toward the concave part.
